(19) United States
(12) Patent Application Publication
(10) Pub. No.: US 2008/0131676 A1
(43) Pub. Date: Jun. 5, 2008

(54) Microporous Breathable Film with Internal Barrier Layer or Layers

(76) Inventors: Gail S. Becke, Hoffman Estates, IL (US); Debra J. Carmody, Greensboro, NC (US); Mark J. Dobosy, Williamsburg, VA (US)

Correspondence Address: MCANDREWS HELD & MALLOY, LTD, 500 WEST MADISON STREET, SUITE 3400, CHICAGO, IL, 60661, US

(21) Appl. No.: 11/869,244

(22) Filed: Oct. 9, 2007

Related U.S. Application Data
(60) Provisional application No. 60/828,736, filed on Oct. 9, 2006.

(51) Int. Cl. B32B 3/26; B32B 7/02; D04H 13/00

(52) U.S. Cl. 428/216; 428/315.9; 442/370

(57) ABSTRACT

Provided are multilayer, microporous breathable barrier films and items such as laminates and garments made from such films. The films contain one or more layers of polymers without fillers in combination with at least two or more microporous breathable layers. The unfilled layers provide a barrier that can effectively allow moisture vapor to pass, but retain fluids and challenge materials.

### RELATED APPLICATIONS

This patent application makes reference to, claims priority to and claims benefit from U.S. Provisional Patent Application Ser. No. 60/828,736, filed on Oct. 9, 2006.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The presently described technology generally relates to a multilayer, microporous breathable barrier film and items such as laminates and garments made therefrom. The films produced by the presently described technology contain one or more layers of polymers without fillers or substantially without fillers in combination with two or more microporous breathable layers. The unfilled polymer layers provide a barrier that can effectively allow moisture vapor to pass but not fluids and challenge materials such as viruses.

Microporous films produced by various means have been used for breathable applications. There are a variety of thermoplastic films available on the market that exhibit breathability and liquid barrier properties. One such group of films is monolithic hydrophilic polymeric films. These films are able to transmit moisture without the additional need of fillers and stretching. The mechanism of breathability is accomplished by absorbing and desorbing moisture. This class of films, however, is expensive to produce and cannot be utilized for extensive end uses where cost containment is necessary. Further, to incorporate opacity characteristics into these films, high levels of pigment are needed, which further increases production costs. Primarily due to such cost concerns, laminates and garments produced from these films are not suitable for disposable applications.

Monolithic and microporous multilayer films are also known. While these films have both viral barrier capabilities as well as breathability, their manufacture is cost prohibitive and their use is not suited for disposable applications. A patent describing the concurrent use of hydrophilic monolithic outer layers and a microporous core layer is U.S. Pat. No. 6,929,853 to Nicholas F. Forte (Kimberly-Clark Worldwide, Inc., Neenah, Wis.). U.S. Pat. No. 6,929,853, in general, describes outer layers of hydrophilic polymeric thermoplastics bonded to a core layer with microporous adhesive layers. This is an expensive structure to produce as it contains the monolithic materials. Another version of this concept is a microporous film laminated with a monolithic film as a barrier, as described in U.S. Pat. No. 5,938,648 to LaVon et al. (Procter & Gamble Co., Cincinnati, Ohio). U.S. Pat. No. 5,938,648 also involves the use of expensive monolithic materials to act as both a barrier and a breathable layer concurrently.

Other common breathable films are microporous films. These films exhibit exceptional breathability, but do not provide a barrier to microorganisms and some liquids depending on the pore size and exposure conditions. Multilayer microporous films are also known in the art. One construction of these films is that of a microporous filled core layer and skin (outside) layers. In U.S. Pat. No. 6,075,179, to McCormack et al. (Kimberly-Clark Worldwide, Inc., Neenah, Wis.), a multilayer film having a skin layer on one side or skin layers on both sides of a particle filled core layer is generally described. The addition of fillers to the core layer was used to potentially reduce costs and/or to impart properties such as breathability and odor reduction. In this particular patent, the skin layers are hydrophobic, but are mechanically cracked open leaving pathways for breathability and also for strikethrough. The choice of polymers and/or additives used in the skin layers depends on the end use, i.e. depending on factors such as antimicrobial activity, water vapor transmission, adhesion and/or antiblocking. However, those trained in the field will understand that a hydrophilic resin would need to be used in the skin layers disclosed in U.S. Pat. No. 6,075,179 to impart appreciable water vapor transmission. Such an inclusion can add costs to the product. Additionally, this structure does not impede the transmission of viruses or other challenge materials such as bacteria or artificial blood as they are able to pass through the cracks in the resultant film's outer skin layer.

Another patent from McCormack, et al. using the same skin/core concept is U.S. Pat. No. 6,682,803 (Kimberly-Clark Worldwide, Inc., Neenah, Wis.). The skin layers comprise incompatible resins. After mechanical stretching, the resins separate from each other forming small cracks. The cracks in the outer skin layers appear to allow for moisture to travel through the film when a microporous core layer is also used. This particular patent further describes two main purposes for the skin layers, which are to allegedly shield the die lips from build up during extrusion and to allegedly serve as a bonding layer when the film is attached to a nonwoven material. Again, this skin/core concept does not impede the transmission of viruses or other challenge materials as they are able to pass through the cracks in the resultant film's outer skin layer.

Other methods of making microporous films involve the phase separation of various polymers, leaving voids and areas of low crystallinity as pathways for breathability. These pathway structures do not impede the transmission of viruses or other challenge materials as they are able to pass through the voids and amorphous areas in the film. These methods are described in U.S. Pat. No. 4,539,256 to Shipman, U.S. Pat. No. 5,260,360 to Mrozinski, U.S. Pat. No. 5,690,949 to Weimer, et al., U.S. Pat. No. 5,738,111 to Weimer, et al. (all five assigned to Minnesota Mining and Manufacturing Co., St. Paul, Minn.), and U.S. Pat. No. 5,938,874 to Palomo, et al. (Allegiance Corporation, McGaw Park, Ill.), among others.

Compared to the breathable films existing in the art, the film of the presently described technology has one or more of the following advantages: (a) can provide opacity at low thicknesses; (b) is cost effective versus hydrophilic monolithic thermoplastics; (c) can be impervious to liquids with surface tensions greater than 30 dynes, such as water, blood, and other body fluids; (d) can allow for moisture vapor transmission through a breathable barrier suitable in multiple applications; and (e) can be resistant to the passage of virus and other microbial challenge materials.

### BRIEF SUMMARY OF THE INVENTION

The presently described technology, in general, relates to multilayer, microporous breathable barrier films and items such as laminates and garments made from such films. The films produced by the presently described technology contain one or more inner layers of polymers without fillers and at least two microporous breathable layers.

A unique aspect of the presently described technology is that even with an inner barrier layer, e.g., a hydrophobic inner layer, and without specifically designed openings, an acceptable level of breathability can be achieved while a viral barrier is maintained. Further, the film structure of the presently described technology can accomplish these goals at a cost that is appropriate for disposable end use applications. For example, when a hydrophobic inner layer is used in accordance with one embodiment of the presently described technology, an acceptable level of breathability can be achieved through the thinning of the hydrophobic inner layers while a viral barrier is maintained.

In one aspect, the presently described technology provides a breathable plastic film comprising at least three layers, with at least one internal barrier layer made from a polyolefin, and at least two outer surface layers made from microporous polyolefin compositions. The microporous polyolefin compositions of the at least two outer surface layers can be the same or different. Preferably, the at least one internal barrier layer has a different infrared signature than the microporous layers. More preferably, the barrier layer contains no filler.

In accordance with at least one embodiment, the breathable plastic film comprises at least five layers of polymers, of which at least two are non-consecutive inner layers comprising the same or different polyolefin.

Preferably, the breathable plastic film of the present technology has a breathability of from about 300 grams/square (sq.) meter/day to about 20,000 grams/sq. meter/day. More preferably, the film can pass ASTM F-1670 or ASTM F-1671 testing.

In another aspect, the presently described technology provides an article or garment produced using a breathable plastic film comprising at least three layers, with at least one internal barrier layer made from a polyolefin, and at least two outer surface layers made from microporous polyolefin compositions.

In still another aspect, the presently described technology provides a laminate comprising a breathable plastic film further comprising at least three layers, with at least one internal barrier layer made from a polyolefin, and at least two outer surface layers made from microporous polyolefin compositions, and a fabric or nonwoven material bonded to at least one side of the film. Preferably, the laminate of the present technology can pass ASTM F-1670 or can pass ASTM F-1671 testing. More preferably, the laminate of the present technology has a breathability of at least about 1000 grams/sq meter/day.

In yet another aspect, the presently described technology provides a laminate with at least one layer of nonwoven material bonded to at least two or more layers of breathable barrier film of the present technology. Preferably, the resultant laminate can pass ASTM F-1670 or ASTM F-1671 testing. More preferably, the laminate has a water vapor transmission rate (WVTR) of at least 1000 grams/sq meter/day when measured by, for example, a MOCON PERMATRAN-W® Model 100K tester.

In still another aspect, the presently described technology provides a laminate with at least one layer of nonwoven material bonded to at least two or more layers of breathable films comprising at least one layer of the barrier layer containing film of the present technology. The preferred additional layer of breathable film is a microporous polyolefin film.

In each of the laminations described herein, the bonding may be thermal, ultrasonic, radio frequency (RF), adhesive, binder fiber, binder powder, and the like.

In a further aspect, the present technology provides an article or garment produced using the laminate of the present technology described herein.

In yet another aspect, the presently described technology provides an article or product for blocking liquid borne pathogens and transporting moisture vapor by using the film or laminate of the present technology.

### BRIEF DESCRIPTION OF SEVERAL VIEWS OF THE DRAWINGS

[Not Applicable]

### DETAILED DESCRIPTION OF THE INVENTION

The presently described technology generally relates to a microporous multilayer film (e.g., coextruded film) comprising at least two layers of microporous polymers with one or more barrier layers of polymers. Preferably, the microporous polymers are filled, more preferably, at a high or significant (from about 30% to about 80%) level, and the polymers for the barrier layers are unfilled or substantially unfilled.

In accordance with at least one embodiment, the films of the presently described technology comprise at least two layers of filled polymers and at least one inner layer of unfilled polymer. The films are co-extruded and then stretched in the machine direction over a series of heated rolls that run at increasing speeds to stretch the film in the machine direction to open micropores between the polymers and the non-extensible filler materials in the microporous layers. This layer construction, when stretched, allows breathability for moisture vapor while maintaining a barrier for fluids with surface tensions greater than 30 dynes, such as water, blood, and other bodily fluids.

While machine direction orientation as described in the above paragraph is a preferred orientation method, it will be understood by those skilled in the art that other methods of film stretching and orientation can be used to achieve the same result. These methods include, but are not limited to, biaxial orientation, transverse direction orientation, and incremental stretching via intermeshing gears, either mono- or bi-axially.

In accordance with at least one embodiment, the film of the presently described technology comprises at least two breathable layers of inorganic or organic filler-containing polyolefin. The filler can be uniformly dispersed in the polyolefin matrix and can be added at levels ranging from about 30% to about 80% by weight, alternatively from about 45% to about 70% by weight, alternatively from about 50% to about 65% by weight. The filler can comprise, for example, calcium carbonate, barium sulfate, talc, glass spheres, or other inorganic particles, organic fillers, organic domains (e.g., polyamides, polyacrylates, styrenes, polystyrenes, and the like), derivatives thereof, or a combination thereof. These breathable layers preferably can constitute from about 80% to about 99.5%, alternatively from about 70% to about 98.5%, alternatively from about 90% to about 98.5% of the total thickness of the multilayer film.

The multiple breathable layers of the present technology can differ from each other in thickness, breathability, pore size, and thermoplastic composition. For example, if the film is used in a composite, a different thermoplastic may be used in the two outer film skin layers to increase adhesion on one or more sides. The type of desired thermoplastic for a specific use would depend on, for example, the lamination technology used as well as process factors. The inner breathable layers could be made from less expensive raw materials. The thickness of each layer can range from about 1% to about 99.5% of the total film thickness as measured by thickness percentage.

Further, the breathability, pore size, and quantity of pores are dependent upon the technology used to stretch the film as well as the specific formulation of the breathable layer. Additives can be added for process needs and for inclusion of additional properties including, but not limited to, pigmentation, antioxidation, antimicrobial effects, odor control, and static decay.

In addition to the breathable layers, the films of the present technology also comprise at least one barrier layer that can make up from about 0.5% to about 20% of the total thickness of the film of the presently described technology as measured by thickness percentage. Preferably, this layer(s) does not contain fillers that provide sites for development of micropores, although additives for other purposes or properties may be used. Typical materials for these barrier layers include, but are not limited to, linear low density polyethylene (LLDPE), low density polyethylene (LDPE), high density polyethylene (HDPE), ethylene/vinyl acetate (EVA), ethyl methacrylate (EMA), polypropylene (PP), copolymers of PP, copolymers of polyethylene (PE) and PP, derivatives thereof, and combinations thereof. A variety of additives may be added to the barrier layers to provide additional properties such as antimicrobial effects, odor control, and static decay. The internal barrier layer(s) is placed in the film to impede the flow of liquids, liquid borne pathogens, and other microorganisms that may be carried by a liquid challenge.

The design of the presently described technology can significantly improve the barrier performance while still allowing moisture vapor transmittance that makes the film breathable and the resulting garments or other articles comfortable. Single or multiple barrier layers may be incorporated into the film and can be placed in any order in the inner layers of the film structure. Preferably, the barrier layers are not to be placed on the outer surface of the resultant film. For maximum effectiveness, it is preferred that multiple barrier layers are not placed next to each other inside the film. When multiple barrier layers are used, the barrier layers in the film can differ from each other in thickness and thermoplastic type. For example, different thermoplastics may be used in two barrier layers to increase internal layer adhesion, if desired. It is also preferable to add components to the barrier layer in order to more easily measure the layer thickness accurately. Such components include, but are not limited to, infrared markers, ethylene/vinyl acetate (EVA), ethyl methacrylate (EMA), pigments, and blends thereof.

In accordance with at least one embodiment of the presently described technology, a preferred structure contains five layers, with one barrier layer being in the core of the structure and four breathable layers (A-B or B-A) in an A-B-C-B-A positioning fashion for the resultant film, wherein A refers to a breathable layer, B refers to a different kind of breathable layer, and C refers to the barrier layer. In one example, the outermost breathable layers (A) contain 9.3% Dow DOWLEX® 2517 LLDPE, 9.3% Dow DOWLEX® 2035 LLDPE, 25.27% Dow Elite® 5230G LLDPE all available from Dow Chemical Company, Midland, Mich., and 56% calcium carbonate, with additional antioxidants, colorants, and processing aids possibly added. The inner breathable layers (B) in this example contain 9.3% Dow DOWLEX® 2517 LLDPE, 9.3% Dow DOWLEX® 2035 LLDPE, 25.27% Dow AFFINITY® PL1280 polyolefin plastomer (POP), all available from Dow Plastics, and 56% calcium carbonate, with additional antioxidants, colorants, and processing aids possibly added. The inner layer (C) in this particular example contains 100% Equistar PETROTHENE®. NA334000 LDPE, available from Lyondell Chemical Company, Houston, Tex. Instead of LDPE, other polyolefins such as LLDPE, EVA, EMA and blends thereof can be utilized as the inner layers. Further, different levels of calcium carbonate as well as other filler materials such as barium sulfate, talc, glass spheres, or other inorganic particles, derivatives thereof, or a combination thereof can be used in the breathable layers.

The presently described technology is not limited to any specific kind of film structure. Other film structures can achieve the same or similar result as the five-layer structure disclosed above. The limitation on film structures is a function of equipment design and capability. For example, the number of layers in a film of the present technology only depends on the technology available and the need of the end uses of the film. Structure examples suitable for the presently described technology include, but are not limited to, the following, where A is a microporous layer and B is a barrier layer:

A-B-A

A-A-B-A

A-B-A-A

A-A-B-A-A

A-B-A-A-A

A-B-A-B-A

A-B-A-A-A-A-A

A-A-B-A-A-A-A

A-A-A-B-A-A-A

A-B-A-A-A-B-A

A-B-A-A-B-A-A

A-B-A-B-A-A-A

A-B-A-B-A-B-A

A-B-A-A-A-A-A-A

A-A-B-A-A-A-A-A

A-A-A-B-A-A-A-A

A-B-A-A-A-A-B-A.

It should be understood that the multiple “A” breathable layers in each of the example structures above can be the same or different kind of microporous layer. Further, it is contemplated that each “A” breathable layer in the above structures could comprise two or more breathable layers in order to better control other film properties, such as the ability to bond to nonwovens. For example, when there are two breathable layers in one “A” breathable layer in the above structures, some exemplary film structures can be shown as follows, where C is the second breathable layer:

A-C-B-C-A

A-C-A-C-B-C-A

A-C-B-C-A-C-A

A-C-A-C-B-C-A-C-A

A-C-B-C-A-C-A-C-A

A-C-B-C-A-B-C-A

Additionally, it is known in the film industry that die technology is available to produce multiple layers in a multiplier fashion so that, for example, an ABA structure could conceivably be multiplied from about 10 to 200 times, as explained in U.S. Pat. No. 5,380,479 to Shrenk, et. al. (Dow Chemical Company, Midland, Mich.). The resulting 10-time multiplied ABA structure can be expressed as follows:

ABAABAABAABAABAABAABAABAABAABA

This technology can be used in combination with the presently described technology, and such application is contemplated within the spirit and scope thereof.

The multilayer film of the presently described technology can be extruded at a thickness of from about 1.5 mils to about 6 mils, alternatively from about 2.0 mils to about 5.5 mils on a cooled chill roll and either wound as a precursor film or fed directly into a machine direction orientation (MDO) stretching unit or other type of orientation or stretching unit as described above. The film can be stretched from about 100% to about 800%, alternatively from about 100% to about 600% in length to induce micropores. With respect to draw ratios, it should be understood by those skilled in the art, for example, that a 100% stretch is achieved by operating the second set of rollers at a speed twice that of a first set of rollers, resulting in a draw ratio of 2.0. The film can be further heated and allowed to anneal to relieve from about 2% to about 30% of the stress induced by the stretching operation.

In accordance with at least one embodiment, the resultant film is from about 0.5 mils to about 2.0 mils, alternatively from about 0.60 mils to about 1.8 mils thick. The finished film can then be wound onto cores for sale or for further processing in, for example, lamination equipment. The resultant breathability achieved for the films can be from about 300 grams (g)/sq. meter (sqm or m²)/day (24 hours (hr)) to about 30,000 g/sqm/day, alternatively from about 1000 to 18000 g/sqm/day. A preferred film of at least one embodiment of the presently described technology has a breathability of from about 3,000 to about 15,000 g/sqm/day and has a thickness of about 0.8 mils. Preferably, the films of the present technology can pass ASTM F-1670 or ASTM F-1671 testing standards. In so doing, the films prevent passage of artificial blood and provide a barrier to viral solutions such that no significant growth occurs in cultures taken from beyond the barrier. Breathability in the presently described technology can be tested by a Mocon PERMATRAN-W® Model 100K machine at 37.8° C. (100° F.) and 100% relative humidity. Use of this testing equipment is an industry practice that one skilled in the art will appreciate how to execute.

The film of the presently described technology is useful for preparing laminates or other structures that are useful for breathable barrier applications. In the presently described technology, the film may be laminated using adhesive, binder fiber, or powder, autogenously using thermal or ultrasonic bonding, or any other method available in the art. Preferably, the laminate made from the films of the present technology can pass ASTM F-1670 or ASTM F-1671 testing standards. Also preferably, the laminate or structures made from the films of the present technology exhibit breathability of at least 1000 grams/sq meter/day, when measured by, for example, a MOCON PERMATRAN-W® Model 100K tester.

Possible applications using the materials of the present technology include, but are not limited to, medical gowns, drapes, packaging, garments, articles, and bandages. It also has uses in, for example, protective apparel, feminine hygiene, building construction, and bedding.

The presently described technology and its advantages will be better understood by reference to the following examples. These examples are provided to describe specific embodiments of the present technology. By providing these specific examples, the applicants do not limit the scope and spirit of the present technology. It will be understood by those skilled in the art that the full scope of the presently described technology encompasses the subject matter defined by the claims appending this specification, and any alterations, modifications, or equivalents of those claims.

Breathability testing of the samples in the following examples was done using a Mocon PERMATRAN-W® Model 100K tester. Viral testing under ASTM F-1671 and F-1670 was conducted by Nelson Laboratories Inc. 6280 S. Redwood Road, Salt Lake City, Utah 84123.

### EXAMPLE 1

### Three Five-Layer Films Having One Barrier Layer

Three 5-layer films of the structure A-A-B-A-A, where B is the barrier layer were produced. The barrier layer thickness was varied from 2%, 5%, and 7% of the total film thickness, respectively in the three films. After stretching, the breathability of the films was tested and the results were listed in Table 1. The viral barrier of the film was tested using two films placed atop each other in a 2-ply configuration and passed ASTM F-1671 and ASTM F-1670 testing.

### EXAMPLE 2

### Three Five-Layer Films Having Two Barrier Layers

Three 5-layer films of the structure A-B-A-B-A were produced at 19 gsm, where each of the B layers (barrier layers) constitutes 1.5%, 3% and 5% of the total film thickness, respectively in the three films. After stretching, the breathability of the films was tested and the results were listed in Table 1. The viral barrier of the film was tested using two films placed atop each other in a 2-ply configuration and passed ASTM F-1671 and ASTM F-1670 testing.

TABLE 1

| | | Pre | | | |
|---|---|---|---|---|---|
| | | MDO | Final | | |
| | | Basis | Basis | WVTR | |
| Exam- | | Weight | Weight | g/m²/ | Stretch |
| ple # | Description | gsm | gsm | day | Conditions |
| Exam- | 1 Barrier LDPE | | | | |
| ple 1 | Layer | | | | |
| | 2% | 66.4 | 19.36 | 15,447 | Draw Ratio = 2.4 |
| | 5% | 66.2 | 20.88 | 11,738 | Draw Ratio = 2.3 |
| | 5% | 66.2 | 21.7 | 10,043 | Draw Ratio = 2.5 |
| | 7% | 66.3 | 21.7 | 11,931 | Draw Ratio = 2.2 |
| Exam- | 2 Barrier LDPE | | | | |
| ple 2 | Layers | | | | |
| | 2 Layers 1.5% | 63.9 | 19 | 15,305 | Draw Ratio = 2.3 |
| | ea | | | | |
| | 2 Layers 3% ea | 62.5 | 19.7 | 14,466 | Draw Ratio = 2.3 |
| | 2 Layers 5% ea | 63 | NA | NA | Produced but |
| | | | | | not Stretched |

Test results indicate that both the 1 and 2 barrier layer designs can provide breathability and a viral barrier.

### EXAMPLE 3

Five films of 19 gsm final thickness with 1 barrier layer having a construction of A-A-B-A-A were produced to test barrier layer thickness and to improve heat sealability of the outer layers for use of the films in laminations. Fourier Transform Infrared Spectroscopy (FTIR) technique was tested as a method for measuring the barrier layer presence and thickness. The WVTR (water vapor transmission rates) of the films were tested at different positions of the films, and the results are recorded in Table 2 below.

TABLE 2

| | | WVTR, g/m²/day | | |
|---|---|---|---|---|
| | | Position 1 - | | Position |
| Sample | | Operator | Position | 3 - Drive |
| Name: | Sample Description: | Side | 2 - Center | Side |
| XP-3960-N | 19 gsm MDO film, | 8683 | 11383 | 9237 |
| | 15 rpm LDPE Core | | | |
| | Thickness, mil | 0.88 | 0.8 | 0.85 |
| XP-3960-O | 19 gsm MDO Film, | 11066 | 10850 | 9784 |
| | 15 rpm EVA/LDPE | | | |
| | Core | | | |
| | Thickness, mil | Not | Not | Not |
| | | measured | measured | measured |
| XP-3960- | 19 gsm MDO Film, | 9785 | 11865 | 10900 |
| O-1 | 20 rpm EVA/LDPE | | | |
| | Core | | | |
| | Thickness, mil | 0.89 | 0.9 | 0.93 |
| XP-3960-Q | 19 gsm MDO film | 8729 | 9173 | 9338 |
| | 20 rpm LDPE Core | | | |
| | Thickness, mil | 0.87 | 0.8 | 0.86 |
| XP-3960-S | 19 gsm MDO Film, | 9784 | 9221 | 8570 |
| | 25 rpm LDPE Core | | | |
| | Thickness, mil | 0.97 | 0.97 | 0.9 |

Thermally laminated samples of a nonwoven-film-film-nonwoven structure were produced from the above films and tested for composite breathability and viral barrier properties. Each laminate was composed of a top and bottom nonwoven fabric layer of 22 gsm spunbonded bicomponent nonwoven. Two layers of the barrier film were sandwiched between the layers of spunbond nonwoven. The bicomponent spunbond was a sheath core material with a polypropylene core and a polyethylene sheath. The laminates were produced on a Kusters thermal bonding calendar with an engraved bonding roll over a smooth anvil roll. The conditions for the lamination experiments are contained in Table 3. The thermal bonding pattern was a geometric ‘dot’ pattern with diamond shaped bond points covering approximately 18.2% of the total area.

The test results are shown in Table 3. These results show that with proper bonding, the completed thermal laminated finished construction passed viral barrier testing and maintains desirable breathability. It further shows that certain films (XP3960S) are more robust to lamination process conditions than others (XP3960N). Without being bound by any particular theory, this can be explained by the thicker barrier layer on the XP3960S as indicated above (25 rpm versus 15 rpm on the LDPE layer extruder).

TABLE 3
Laminates Final Construction Results

| | | | 1670 Viral | | |
|---|---|---|---|---|---|
| | Lami- | Lami- | (# of | | |
| | nation | nation | Challenges, | Film | Composite |
| Sample | Pressure | Temp | Results) | MVTR | MVTR |
| XP3960N-400-3 | 400 pli | 245 F. | 3 Pass | 9000 | 4700 |
| XP3960N-450-3 | 450 pli | 245 F. | 3 Fail | 9000 | 4400 |
| XP3960-0 | NA | NA | 2 Fail | NA | NA |
| XP3960R-450-2 | 450 pli | 200 F. | 2 Fail | 10800 | 4002 |
| XP3960S-450-2 | 450 pli | 200 F. | 3 Pass | NA | 3250 |
| XP3960S-400-3 | 400 pli | 245 F. | 3 Pass | NA | 3900 |

In addition, the barrier layer thicknesses of the XP3960O and XP3960O1 films were able to be detected and quantified via FTIR, as compared to the other films in this example where the barrier layer thickness was not quantifiable analytically.

### EXAMPLE 4

Four films with barrier layers of construction A-A-B-A-A and 1 film of construction A-A-A-A-A were produced to test barrier layer composition and provide thermal laminates of Nonwoven-Film-Film-Nonwoven samples for lamination and evaluation. The results of the breathability and viral barrier tests are recorded in Table 4. The viral testing indicates LDPE, LLDPE, and LLDPE-EVA barrier layers provided good viral barrier properties in the samples. Additionally, heavier films such as XP3960-V5 and XP-3960-V4 also possess good breathability and good viral barrier properties. Further, these results also indicate good viral protection is obtained when 2-ply combinations of a breathable film of construction A-A-A-A-A and a film with a barrier layer of A-A-B-A-A are paired together, implying that a single layer of AABAA construction is sufficient to create the necessary viral barrier characteristics.

TABLE 4

| | | | Basis Wt | WVTR | Viral |
|---|---|---|---|---|---|
| | | | Avg | Avg | Barrier |
| Product Code | Goal | Structure | gsm | g/m²/day | ASTM 1671 |
| XP-3960-V2 | Control | AABAA | 19.5 | 9246.0 | Not tested |
| | LDPE | | | | |
| | Center | | | | |
| XP-3960-V4 | 24 gsm | AABAA | 23.5 | 7764.0 | Not tested |
| | Final | | | | |
| | Thickness | | | | |
| | LDPE | | | | |
| | Center | | | | |
| XP-3960-V5 | 34 gsm | AABAA | 34.4 | 7132.0 | Preliminary 3 of 3 |
| | Final | | | | pass Single Film |
| | Thickness | | | | Layer & Full |
| | LDPE | | | | Laminate |
| | Center | | | | |
| XP-3960-X6 | LLD Center | AABAA | 19.4 | 9943.0 | Preliminary 3 of 3 |
| | Layer | | | | Pass Double Film |
| | Reduced | | | | & Full Laminate |
| XP-3960-X4 | LLD flow | AABAA | 19.9 | 6449.0 | Preliminary 3 of 3 |
| | mapping | | | | Pass Double (2- |
| | EVA in | | | | ply) Film |
| | center | | | | |
| XP-3960-W2 | Blue with | AAAAA | 19.6 | 13423.0 | 2 ply construction |
| | Breathable | | | | of 1 layer V2 + 1 |
| | Center | | | | layer W2 |
| | Layer | | | | Full Laminate 3 of |
| | | | | | 3 Passed |

What is claimed is:

1. A breathable film comprising:
at least one internal barrier layer comprising at least one polyolefin;
at least one first outer layer comprising at least one first microporous polyolefin composition; and
at least one second outer layer comprising at least one second microporous polyolefin composition.

2. The breathable film of claim 1, wherein the first and second microporous polyolefin compositions are the same.

3. The breathable film of claim 1, wherein the first and second microporous polyolefins compositions are different from each other.

4. The breathable film of claim 1, wherein the first and second outer layers contain at least one filler.

5. The breathable film of claim 4, wherein the filler is a member selected from the group consisting of calcium carbonate, barium sulfate, talc, glass spheres, inorganic particulates, organic fillers, organic domains, nanoparticulates, fibers, derivatives thereof, and combinations thereof.

6. The breathable film of claim 1, wherein the internal barrier layer has a different infrared signature than the first or second outer layers.

7. The breathable film of claim 1, wherein the internal barrier layer is substantially free of filler.

8. The breathable film of claim 1, further comprising at least two non-consecutive internal barrier layers; and at least one microporous layer between each non-consecutive internal barrier layer.

9. The breathable film of claim 1, wherein the film has a breathability of from about 300 grams/sq. meter/day to about 20,000 grams/sq. meter/day.

10. The breathable film of claim 1, wherein the film has a thickness of from about 0.5 mils to about 2.0 mils.

11. The breathable film of claim 1, wherein the film passes the ASTM F-1670 test, impeding the passage of artificial blood solutions, viruses, bacteria, and fluids with surface tensions greater that 30 dynes.

12. The breathable film of claim 1, wherein the film passes the ASTM F-1671 test.

13. The breathable film of claim 1, wherein the film has a breathability of at least about 1000/grams/sq. meter/day.

14. The breathable film of claim 1, wherein the film has a percent stretch of from about 100% to about 800%.

15. An article comprising the film of claim 1.

16. The article of claim 15, wherein the article is a member selected from the group consisting of medical gowns, drapes, packaging, garments, bandages, protective apparel, feminine hygiene products, building construction materials, and bedding.

17. The article of claim 16, wherein the article is a garment or attached to a garment.

18. The article of claim 17, wherein the garment or the attachment to a garment is disposable.

19. A laminate comprising the film of claim 1 and at least one fabric or at least one nonwoven material bonded to at least one side of the film, wherein the laminate has a breathability of at least about 1000 grams/sq. meter/day.

20. The laminate of claim 19, wherein the film of claim 1 further comprises at least one filler in at least one layer of the film.

21. The laminate of claim 20, wherein the filler is a member selected from the group consisting of calcium carbonate, barium sulfate, talc, glass spheres, inorganic particulates, organic fillers, organic domains, nanoparticulates, fibers, derivatives thereof, and combinations thereof.

22. The laminate of claim 19, wherein the laminate is disposable.

23. The laminate of claim 19, wherein the laminate passes the ASTM F-1671 test.

24. The laminate of claim 19, wherein the laminate passes the ASTM F-1670 test.

25. The laminate of claim 19, wherein the laminate is further incorporated into a member selected from the group consisting of medical gowns, drapes, packaging, garments, bandages, protective apparel, feminine hygiene products, building construction materials, and bedding.
